(19) United States
(12) Patent Application Publication
(10) Pub. No.: US 2018/0052443 A1
(43) Pub. Date: Feb. 22, 2018

(54) High Speed Jet Flux Control and Monitoring System

(71) Applicant: INTERFLUX SINGAPORE PTE LTD, Singapore (SG)

(72) Inventors: Willem Jeanne V. Van Riet, Singapore (SG); Erik Poortman, Singapore (SG)

(21) Appl. No.: 15/552,923

(22) PCT Filed: Feb. 24, 2016
(86) PCT No.: PCT/IB2016/050989

§ 371 Date: Aug. 23, 2017

Related U.S. Application Data
(60) Provisional application No. 62/120,271, filed on Feb. 24, 2015.
(60) Provisional application No. 62/120,276, filed on Feb. 24, 2015.

(51) Int. Cl. G05B 19/4065; B05B 12/08; B23K 3/08

(52) U.S. Cl. CPC G05B 19/4065; B05B 13/041; B23K 3/082; B05B 12/082

(57) ABSTRACT

A control system for a fluxer, the control system comprising: a variable speed pump configured to provide pressurised flow of liquid flux from a flux supply tank; a pulse-width-modulated (PWM) valve coupled to the variable speed pump; a jet nozzle coupled to the PWM valve and configured to eject a jet of flux drops onto a substrate to form flux points, lines or areas thereon; and a controller coupled to the variable speed pump and the PWM valve; wherein the controller is configured to generate PWM signals to control the PWM valve, and pump speed signals to control the variable speed pump, to thereby selectively and individually control volume of individual flux drops, and pressure and flow of the liquid flux, to form the flux points, lines or areas on the substrate.

### FIELD

The present invention relates to control and monitoring of high speed jet flux machines (fluxers).

### BACKGROUND

Fluxers apply soldering flux to printed circuit boards (PCBs).

Conventional fluxers, such as spray fluxers, have various problems. They use a pressure tank with compressed air to supply liquid flux to a spray nozzle. Compressed air is then also used at the nozzle to atomize the flux. The nozzle then moves back and forth to spray entire pallets holding PCBs. Areas on the pallet are sprayed with flux where no soldering necessary, wasting the flux and making the pallets dirty. Also the same amount is being sprayed everywhere, since the pressure and volume is constant over the entire pallet. In addition, a significant amount of flux is lost in the air due to the atomization.

Furthermore, the air-powered nozzles of conventional spray fluxers tend to become clogged easily and frequently. Conventional spray fluxers have no monitoring for determining whether the spray nozzle is operating properly. So if anything goes wrong, such as no air or flux, the PCBs will not get the proper amount of flux and they will thus be soldered improperly, scrapping them.

In this context, there is a need for solutions that address the above problems.

### SUMMARY

According to a first aspect of the present invention, there is provided a control system for a fluxer, the control system comprising:

a variable speed pump configured to provide pressurised flow of liquid flux from a flux supply tank;

a pulse-width-modulated (PWM) valve coupled to the variable speed pump;

a jet nozzle coupled to the PWM valve and configured to eject a jet of flux drops onto a substrate to form flux points, lines or areas thereon; and

a controller coupled to the variable speed pump and the PWM valve;

wherein the controller is configured to generate PWM signals to control the PWM valve, and pump speed signals to control the variable speed pump, to thereby selectively and individually control volume of individual flux drops, and pressure and flow of the liquid flux, to form the flux points, lines or areas on the substrate.

The controller may be further configured to receive valve feedback signals from the PWM valve, and monitor the PWM valve based on the valve feedback signals.

The controller may be further configured to receive pump feedback signals from the variable speed pump, and monitor the variable speed pump based on the pump feedback signals.

The PWM valve may be a solenoid valve.

The controller may be a programmable logic controller (PLC).

The substrate may be a PCB or a pallet holding one or more PCBs.

The jet nozzle may be movable on an X, Y gantry coupled to the controller, and the controller may be further configured to control movement of the jet nozzle.

The jet nozzle may be angularly positionable with respect to the substrate to eject an angled jet of flux drops onto the substrate or into, but not through, holes formed in the substrate.

The jet nozzle may comprise a nozzle plate having a hole formed therethrough to eject the jet of flux drops, wherein the nozzle plate comprises a low-adhesion material, such as polytetrafluoroethylene (or Teflon®).

The flux supply tank may have a flow-restricted inlet.

The system may further comprise an air bubble sensor configured to detect presence of air in the pressurised flow of the liquid flux from the flux supply tank to the jet nozzle.

According to a second aspect of the present invention, there is provided a control method for a fluxer, the control method comprising:

providing a variable speed pump configured to provide pressurised flow of liquid flux from a flux supply tank;

providing a PWM valve coupled to the variable speed pump; providing a jet nozzle coupled to the PWM valve and configured to eject a jet of flux drops onto a substrate to form flux points, lines or areas thereon;

generating PWM signals to control the PWM valve, and pump speed signals to control the variable speed pump, to thereby selectively and individually control volume of individual flux drops, and pressure and flow of the liquid flux, to form the flux points, lines or areas on the substrate.

The method may further comprise receiving valve feedback signals from the PWM valve, and monitoring operation of the PWM valve based on the valve feedback signals.

The method may further comprise receiving pump feedback signals from the variable speed pump, and monitoring the variable speed pump based on the pump feedback signals.

According to a third aspect of the present invention, there is provided a monitoring system for a fluxer, the monitoring system comprising:

PWM valve coupled to a source of liquid flux under pressure;

a controller coupled to the PWM valve and configured to transmit PWM signals to the PWM valve;

a jet nozzle coupled to the PWM valve and configured to eject a jet of flux drops onto a substrate; and

an optical sensor coupled to the controller and configured to detect individual flux drops ejected from the jet nozzle;

wherein the controller is further configured to monitor operation of the jet nozzle based on detections of individual flux drops.

The controller may be further configured to receive feedback signals from the PWM valve, and monitor the PWM valve based on the feedback signals.

The PWM valve may be a solenoid valve.

The controller may be a PLC.

The substrate may be a PCB or a pallet holding one or more PCBs.

The jet nozzle may be movable on an X, Y gantry coupled to the controller.

The controller may be further configured move the jet nozzle to a purging station to be purged if a predetermined number of individual jet drops is not detected.

The controller may be further configured to generate an alarm if a predetermined number of individual jet drops is not detected after the jet nozzle has been purged.

The optical sensor may be a laser sensor.

According to a fourth aspect of the present invention, there is provided a monitoring method for a fluxer, the monitoring method comprising:

detecting individual flux drops ejected from a jet nozzle coupled to a PWM valve that is coupled to a source of liquid flux under pressure and a controller configured to transmit PWM signals to the PWM valve;

monitoring operation of the jet nozzle based on detections of individual flux drops.

The method may further comprise receiving feedback signals from the PWM valve, and monitoring operation of the PWM valve based on the feedback signals.

The method may further comprise moving the jet nozzle to a purging station to be purged if a predetermined number of individual jet drops is not detected.

The method may further comprise generating an alarm if a predetermined number of individual jet drops is not detected after the jet nozzle has been purged.

The present invention further provides a fluxer comprising the control or monitoring system described above, or configured to perform the control or monitoring method described above.

### BRIEF DESCRIPTION OF DRAWINGS

Embodiments of the invention will now be described by way of example only with reference to the accompanying drawings, in which:

FIGS. 1A and 1B are schematic and partial detail views of a flux supply control system for fluxers according to an embodiment of the present invention;

FIGS. 2A, 2B and 2C are graphs of pulse trains, flux points and flux lines generated by the flux supply system;

FIGS. 3 and 4 are schematic side views of the flux supply system respectively showing aligned and angled nozzle bodies;

FIGS. 5A and 5B are schematic and partial detail views of a flux monitoring system for fluxers according to another embodiment of the present invention;

FIGS. 6A and 6B are graphs of pulse trains generated by the flux monitoring system; and

FIG. 7 is a flowchart of a monitoring method of operating the flux monitoring system.

### DETAILED DESCRIPTION

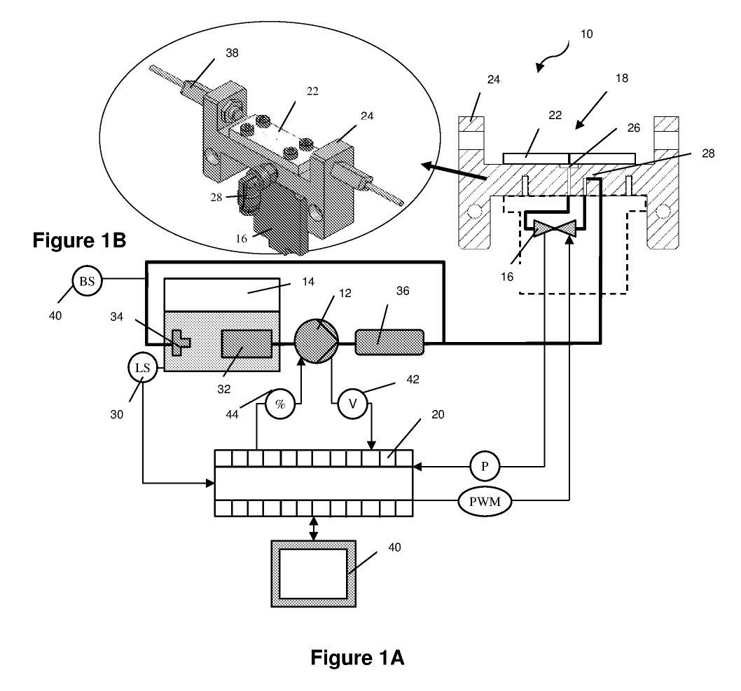

Embodiments of the present invention provide control systems and related control methods, and monitoring systems and related monitoring methods, for jet fluxers. The control and monitoring aspects of the present invention complement and interact with each other, and are specially adapted to be used together to synergistically control and monitor jet fluxers. FIGS. 1 to 4 illustrate embodiments of the control system and control method according to the first and second aspects of the invention. Referring to FIG. 1, a flux supply control system 10 for fluxers according to an embodiment of the present invention, may generally comprise a variable speed pump 12 configured to provide pressurised flow of liquid flux from a flux supply tank 14. A PWM valve 16, such as a high frequency solenoid valve, may be fluidly coupled to the variable speed pump 12. A jet nozzle 18 may be fluidly coupled to the PWM valve 16 and configured to eject a jet of flux drops onto a substrate (not shown) to form flux points, lines or areas thereon. The substrate may be a PCB or a pallet holding one or more PCBs.

A controller 20, such as a PLC, may be electrically coupled to the variable speed pump 12 and the PWM valve 16. The controller 20 may be configured to generate PWM signals to control the PWM valve 16, and pump speed signals to control the variable speed pump 12, to thereby selectively and individually control volume of individual flux drops, and pressure and flow of the liquid flux, to form the flux points, lines or areas on the substrate. The controller 20 may be further configured to receive valve feedback signals from the PWM valve 16, and monitor the PWM valve 16 based on the valve feedback signals. The controller 20 may be further configured to receive pump feedback signals from the variable speed pump 12, and monitor the variable speed pump 12 based on the pump feedback signals. The jet nozzle 18 may be movable at high speed on an X, Y gantry (not shown) electrically coupled to the controller 20, and the controller 20 may be further configured to control movement of the jet nozzle 18.

The jet nozzle 18 may comprise a nozzle plate 22 sealingly mounted on a nozzle body 24 by a nozzle 0-ring 26. The nozzle body 24 may be made of metal, such as stainless steel, and machined to high tolerance. The nozzle plate 22 may be made of a low friction (or low adhesion) material, such as polytetrafluoroethylene (PTFE) (or Teflon®), and has a small hole to direct the jet of flux drops. The low friction material may inhibit flux sticking to the nozzle plate 22 and the hole becoming clogged. The holes may be made to exact tolerances so that no calibration is necessary when removing and replacing the nozzle plate 22 from the nozzle body 24. An L-shaped flux connector 28 provides an inlet for liquid flux at the nozzle body 24. The flux connector 28 may rotate freely to not upset flux tubes while the nozzle body 24 is moving at high speed.

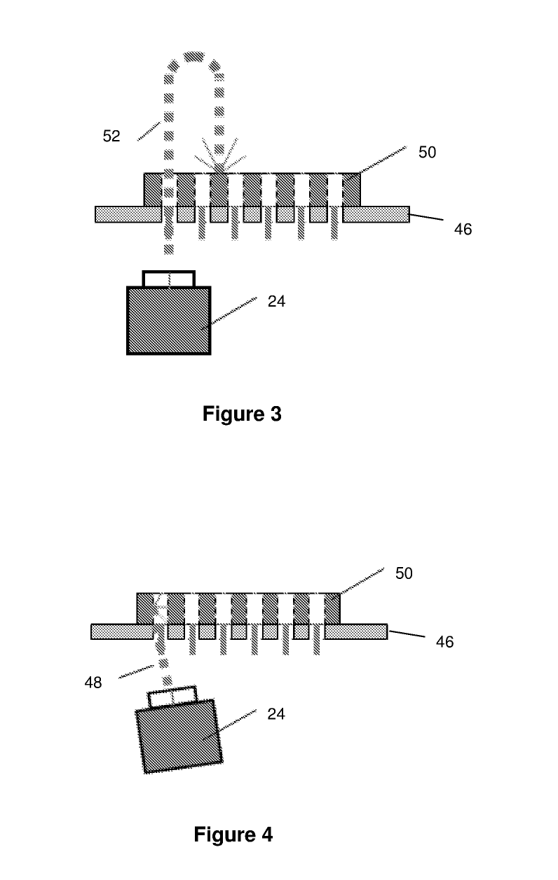

Referring to FIG. 4, the nozzle body 24 may be angularly positionable with respect to the substrate or PCB 46 to eject an angled (or inclined) jet 48 of flux drops onto the PCB 46 or into, but not through, holes formed in the substrate 46. The angled flux jet stream 48 is inclined relative to the plane of the PCB 46 and thereby prevents a right-angled (or perpendicular) flux jet 52 from shooting vertically through a connector 50 and falling vertically back onto the PCB 46 under gravity, as illustrated in FIG. 3.

The flux supply tank 14 may be made of metal, such as stainless steel, and may be refillable while the flux machine is running. The flux supply tank 14 may comprise a drain valve to drain flux away and a low level switch 30 to indicate when the level of the flux falls below a certain level. A flux filter 32, such as a stainless steel filter, may be provided to stop any particles from potentially clogging up the variable speed pump 12 and PWM valve 16. The flux supply tank 14 may further comprise a flow-restricted inlet 34 made of a needle of low friction material, such as PTFE, to create a predetermined amount of pressure in the flux circuit. The flow-restricted inlet 34 may have a hole to restrict the flux flowing in the circuit, thus generating a predetermined minimum amount of pressure in the flux supply circuit.

The variable speed pump 12 may be custom designed to resist the at times corrosive flux. The variable speed pump 12 may be speed controlled and may circulate the flux around the circuit creating a predetermined flow of flux. As mentioned above, because of the flow-restricted inlet 34 in the flux supply tank 14, the flow of liquid flux may be restricted, creating a certain amount of pressure in the circuit that may be selected varied by controlling the speed of the variable speed pump 12. With these variables both the flow and the pressure of the flux for each flux point, line or area may be selectively and individually controlled. Because of the circulation there may be a constant flow and pressure of flux at the PWM valve 16 which may be used at any time by opening it, thus eliminating any surge or buildup in pressure when the PWM valve 16 is opened for the first time. A buffer 36 may be used to remove any bubbles or pulsation generated by the variable speed pump 12. Further, an air bubble sensor 40, such as an ultrasonic sensor, may be configured to detect presence of air in the supply of the pressurised flow of the liquid flux from the flux supply tank 14 to the jet nozzle 18. The air bubble sensor 40 may be connected to the controller 20 that may in turn be configured to generate an alarm when air bubbles are detected.

The variable speed pump 12 may be controlled via an analog 0 to 5 V pump speed signal 42 which controls the pump speed between 0 to 100%. The variable speed pump 12 may have an inbuilt speed pulse generator 44 that generates 6 pulses per mechanical revolution. This pump feedback signal may go to the controller 20 where it is put through a first degree filter to flatten out the oscillation before being monitored to provide feedback on the cleanliness of the flux filter 32 and variable speed pump 12.

The high frequency PWM valve 16 may be used to create (or generate), and selectively and individually control, the flux jet drops. The PWM valve 16 may control the volume of flux dispensed by opening and closing a certain amount of time, for example, milliseconds. The PWM valve 16 may be controlled by the controller 20 using PWM signals which varies the Pulse On time and the Pulse Off time. In this way, flux lines may be jetted at high speed by shooting drops at a certain interval. The density of the flux may be adjusted by varying the Pulse On and the Pulse Off values, as well as the movement speed of the jet nozzle 18. The PWM valve 16 may feedback the amount of pulses to the controller 20 which may monitor operation of the PWM valve 16.

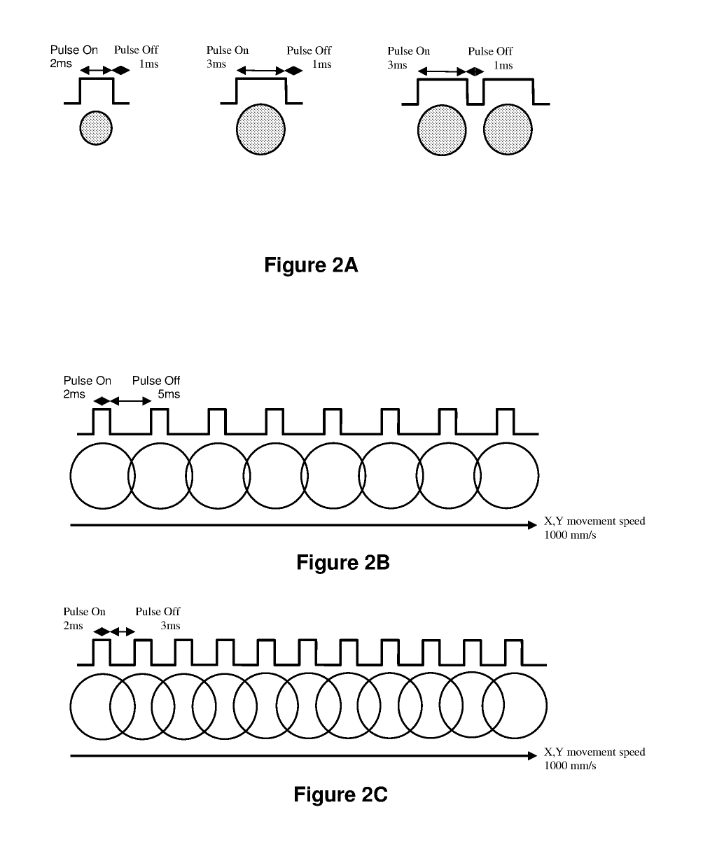

FIGS. 2A to 2C illustrate the relation between pulses, and valve opening and closing times (ie, Pulse On and Pulse Off times). For example, FIG. 2A illustrates that increasing Pulse On time increases the volume of individual flux drops, and that multiple flux drops may be shot at the same location with the time between the shots being the Pulse Off time. FIG. 2B illustrates that flux lines may be generated by a certain Pulse On and Pulse Off combination to generate overlapping flux drops. This may ensure that the flux line is consistent at a certain movement speed of the jet nozzle 18. So the slower the X, Y movement of the jet nozzle 18, the closer the flux points will be spaced together. FIG. 2C illustrates that an increased Pulse On time may result in increased size drops (ie, more flux volume) as explained above. Reduced Pulse Off time may cause the flux drops to be spaced closer together, and vice versa.

As mentioned above, the PWM valve 16 may feedback the pulses to the controller 20 which may monitor the amount of pulses to indicate the start or finish of a flux line and the number of drops per flux point. It may also be used to monitor the health of the PWM valve 16 itself. As also mentioned above, the highly customized PWM signal from the controller 20 may control the volume of the flux drops or dots, as well as the spacing of the dots on a flux line. A laser sensor 38 may be provided on the nozzle body 24 to detect each flux drop being jetted by the nozzle plate 22 and feed the information back to the controller 20.

The controller 20 may control all the sequences and functions of the fluxer and may run completely independently from an interface personal computer (PC) 40. The PC 40 may run interface software, such as flux designer software, where all the flux points, lines or areas may be indicated, and all variables may be adjusted for each flux point, line or area.

Embodiments of the present invention provide a flux supply control system for fluxers to apply flux on PCBs. The flux may be supplied from a flux tank by a flux pump, which circulates the flux around and back to the tank through a restriction. This enables the pump to vary flow and pressure of the flux. The flux is then supplied to a flux valve, which can vary the volume of the flux by rapidly opening and closing itself. The valve creates flux drops that will shoot through a non-stick PFTE flux nozzle. Embodiments of the invention are thus able to change volume, pressure and flow for each and every flux point, line or area on the PCB. Embodiments of the invention greatly increase the flexibility and quality of the fluxing, and greatly decrease the flux usage, maintenance and pollution on the fluxing machine, as well as the soldering machines after the fluxing machine.

Embodiments of the flux supply control system can deposit flux anywhere on the pallet selectively, eliminating the need to flux the entire pallet. They also do not atomize the flux, thus applying 100% of the flux on the location where flux is needed by the use of the flux valve. This valve can very accurately control the volume of the flux applied on each point, line or area. And furthermore, because a flux pump is used to supply the flux instead of a pressure tank, it is possible to change pressure and flow for each flux point, line or area. All of these improvements make it possible to reduce the flux usage by up to 95% and greatly increase the soldering quality and decrease the flux residue since flux can be selectively applied at different volume, pressure and flow.

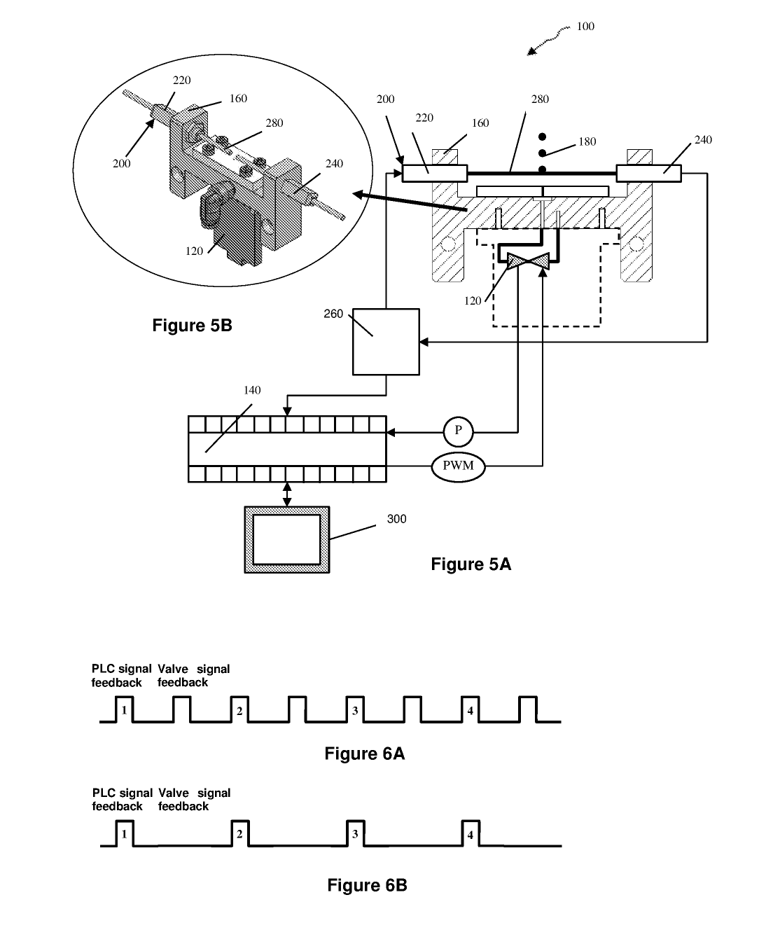

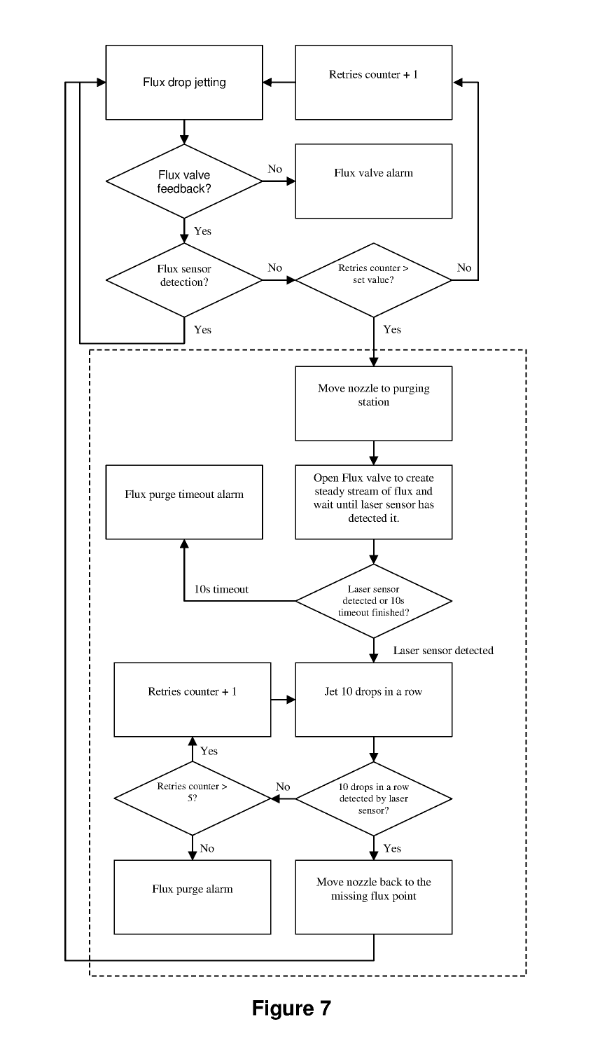

FIGS. 5 to 7 illustrate embodiments of the monitoring system and monitoring method according to the third and fourth aspects of the invention. Referring to FIG. 5, a flux monitoring system 100 for fluxers according to an embodiment of the present invention, may generally comprise a PWM valve 120, such as a high frequency solenoid valve, coupled to a source of liquid flux under pressure. The PWM valve 120 may be coupled to a controller 140, such as a PLC, that is configured to transmit PWM signals to the PWM valve 120. The monitoring system 100 may further comprise a jet nozzle 160 coupled to the PWM valve 120 and configured to eject a jet of flux drops 180 onto a substrate (not shown), such as a PCB or a pallet holding one or more PCBs. The individual flux drops may, for example, have a volume of around 0.003 ml.

An optical sensor 200, such as a high frequency laser sensor, may be coupled to the controller 140 and configured to detect individual flux drops 180 ejected from the jet nozzle 160. The laser sensor 200 may comprise a laser transmitter 220, a laser receiver 240 and a laser amplifier 260 coupled to the controller 140. The laser transmitter 220 may generate a laser beam 280 across the jet nozzle 160 to be received by the laser receiver 240. Interruptions of the laser beam 280 by individual flux drops 180 may be detected by the laser receiver 240, and corresponding high frequency signals may be sent to the controller 140 by the laser amplifier 260.

The controller 140 may be further configured to monitor operation of the jet nozzle 160 based on detections of individual flux drops 180. The jet nozzle 160 may be movable on an X, Y gantry (not shown) coupled to the controller 140. As described above, the jet nozzle 160 may be angularly positionable relative to the substrate or PCB. The controller 140 may be further configured move the jet nozzle 160 to a purging station (not shown) to be purged with a purging or cleaning fluid if a predetermined number of individual jet drops 180 is not detected. The controller 140 may be further configured to generate an alarm if a predetermined number of individual jet drops 180 is not detected after the jet nozzle 160 has been purged. For example, the controller 140 may be programmed to implement the method illustrated in FIG. 6.

The controller 140 may be further configured to receive feedback signals from the PWM valve 120, and monitor the PWM valve 120 based on the feedback signals. The PWM valve 120 may feedback the amount of feedback signal pulses to the controller 140, which will monitor the valve health in this way. Further, the PWM valve 120 may feedback the feedback signal pulses to the controller 120 which may monitor the amount of pulses to indicate the start or finish of a line and the number of drops 180 per flux point. The feedback signal pulses may also be used to monitor the health of the PWM valve 120 itself by checking the feedback signal. For example, the PWM signals from the controller 140 may be counted to indicate the number of drops 180, and the corresponding feedback signals received from the PWM valve 120 may indicate a healthy solenoid coil of the PWM valve 120. Conversely, the PWM signals from the controller 140 may be counted to indicate the intended number of drops 180, but the absence of corresponding feedback signals received from the PWM valve 120 may indicate a faulty coil of the PWM valve 120.

For example, FIGS. 6A and 6B illustrate PWM pulse trains generated and received by the controller 14. In FIG. 6A, the presence of both PWM signals 1, 2, 3, 4 from the controller 140 and corresponding feedback signals from the PWM valve 120 indicates that it is operating correctly. In FIG. 6B, the absence of feedback signals from the PWM valve 120 corresponding to the PWM signals 1, 2, 3, 4 indicates that the PWM valve 120 is faulty. In this case, the controller 140 may be further configured to generate an alarm to indicate that the PWM valve 120 may need to be serviced or replaced.

The controller 140 may control all the sequences and functions of the fluxer and may run completely independently from an interface 300. The PC 300 may run interface software, such as flux designer software, where all the flux points, lines or areas may be indicated, and all variables may be adjusted for each flux point, line or area. The PC 300 may show the alarms generated by the controller 140. The controller 140 may pick up the feedback signals from both the PWM valve 120 and laser sensor 200 and process them accordingly in the sequences. If no feedback signal is detected from the PWM valve 120, an alarm is generated. If the laser sensor 200 detects no flux drop 180, the monitoring system 100 may retry the point or the lines a set number of times. If after the set number of times still no flux drop 180 is detected, the monitoring system 100 may move to the purging station and perform an automatic purge. After this step the monitoring system 100 may continue the fluxing. If the automatic purge is not successful, an alarm may be generated.

Embodiments of the present invention provide a flux monitoring system and monitoring method for fluxers. Embodiments of the invention may be capable of detecting flux jet drops at high speed and using the information to perform closed loop monitoring on the flux application without operator input. This ensures correct application of flux on the PCB. The flux drops may be detected by a high frequency laser sensor that relays the information to a PLC. The PLC uses the information to determine whether to retry the current failed flux point or line, or to go to the purging station and perform an automatic purge. All retry and purge information may be stored in a database for reference and traceability.

Embodiments of the invention may prevent inadequate fluxing by checking each and every drop coming out of the flux jet nozzle without any operator input. If any drop is not detected, the system may retry a set number of times to try to correct the issue. If after a set number of times flux is still not being detected, the system may instruct the flux jet nozzle to move to the purging station and perform an automatic purge. This may clean the nozzle and will remove any air bubbles. In case the automatic purge also fails, an alarm may be generated. In addition, the flux valve feedback may be monitored to determine the valve coil health. An alarm may be generated if the valve fails. All these measures are designed to ensure a proper application of the flux on the PCBs, ensuring a consistent better soldering quality.

It will be appreciated that the control and monitoring aspects of the present invention complement and interact with each other, and are specially adapted to be used together to synergistically control and monitor operation of jet fluxers. For example, a single controller may be configured to implement both the flux control and flux monitoring functionalities.

For the purpose of this specification, the word “comprising” means “including but not limited to,” and the word “comprises” has a corresponding meaning.

The above embodiments have been described by way of example only and modifications are possible within the scope of the claims that follow.

1. A control system for a fluxer, the control system comprising:
a variable speed pump configured to provide pressurised flow of liquid flux from a flux supply tank;
a pulse-width-modulated (PWM) valve coupled to the variable speed pump;
a jet nozzle coupled to the PWM valve and configured to eject a jet of flux drops onto a substrate to form flux points, lines or areas thereon; and
a controller coupled to the variable speed pump and the PWM valve;
wherein the controller is configured to generate PWM signals to control the PWM valve, and pump speed signals to control the variable speed pump, to thereby selectively and individually control volume of individual flux drops, and pressure and flow of the liquid flux, to form the flux points, lines or areas on the substrate.

2. The system of claim 1, wherein the controller is further configured to receive valve feedback signals from the PWM valve, and monitor the PWM valve based on the valve feedback signals.

3. The system of claim 1, wherein the controller is further configured to receive pump feedback signals from the variable speed pump, and monitor the variable speed pump based on the pump feedback signals.

4. The system of claim 1, wherein the PWM valve is a solenoid valve.

5. The system of claim 1, wherein the controller is a programmable logic controller.

6. The system of claim 1, wherein the substrate is a PCB or a pallet holding one or more PCBs.

7. The system of claim 1, wherein the jet nozzle is movable on an X, Y gantry coupled to the controller, and wherein the controller is further configured to control movement of the jet nozzle.

8. The system of claim 1, wherein the jet nozzle is angularly positionable with respect to the substrate to eject an angled jet of flux drops onto the substrate or into, but not through, holes formed in the substrate.

9. The system of claim 1, wherein the jet nozzle comprises a nozzle plate having a hole formed therethrough to eject the jet of flux drops, wherein the nozzle plate comprises a low-adhesion material.

10. The system of claim 9, wherein the low-adhesion material is polytetrafluoroethylene.

11. The system of claim 1, wherein the flux supply tank has a flow-restricted inlet.

12. The system of claim 1, further comprising an air bubble sensor configured to detect presence of air in the pressurised flow of the liquid flux from the flux supply tank to the jet nozzle.

13. A control method for a fluxer, the control method comprising:
providing a variable speed pump configured to provide pressurised flow of liquid flux from a flux supply tank;
providing a pulse-width-modulated (PWM) valve coupled to the variable speed pump;
providing a jet nozzle coupled to the PWM valve and configured to eject a jet of flux drops onto a substrate to form flux points, lines or areas thereon;
generating PWM signals to control the PWM valve, and pump speed signals to control the variable speed pump, to thereby selectively and individually control volume of individual flux drops, and pressure and flow of the liquid flux, to form the flux points, lines or areas on the substrate.

14. The method of claim 13, further comprising receiving valve feedback signals from the PWM valve, and monitoring operation of the PWM valve based on the valve feedback signals.

15. The control method of claim 13, further comprising receiving pump feedback signals from the variable speed pump, and monitoring the variable speed pump based on the pump feedback signals.

16. A fluxer comprising the control system of claim 1.

17. A fluxer configured to perform the control method of claim 13.

18. A monitoring system for a fluxer, the monitoring system comprising:
a pulse-width-modulated (PWM) valve coupled to a source of liquid flux under pressure;
a controller coupled to the PWM valve and configured to transmit PWM signals to the PWM valve;
a movable jet nozzle coupled to the PWM valve and configured to eject a jet of flux drops onto a substrate; and
an optical sensor coupled to the controller and configured to detect individual flux drops ejected from the jet nozzle;
wherein the controller is further configured to monitor operation of the jet nozzle based on detections of individual flux drops.

19. The system of claim 18, wherein the controller is further configured to receive feedback signals from the PWM valve, and monitor the PWM valve based on the feedback signals.

20. The system of claim 18, wherein the PWM valve is a solenoid valve.

21. The system of claim 18, wherein the controller is a programmable logic controller.

22. The system of claim 18, wherein the substrate is a printed circuit board (PCB) or a pallet holding one or more PCBs.

23. The system of claim 18, wherein the jet nozzle is movable on an X, Y gantry coupled to the controller.

24. The system of claim 23, wherein the controller is further configured move the jet nozzle to a purging station to be purged if a predetermined number of individual jet drops is not detected.

25. The system of claim 24, wherein the controller is further configured to generate an alarm if a predetermined number of individual jet drops is not detected after the jet nozzle has been purged.

26. The system of claim 18, wherein the optical sensor is a laser sensor.

27. A monitoring method for a fluxer, the monitoring method comprising:
detecting individual flux drops ejected from a movable jet nozzle coupled to a PWM valve that is coupled to a source of liquid flux under pressure and a controller configured to transmit PWM signals to the PWM valve;
monitoring operation of the jet nozzle based on detections of individual flux drops.

28. The method of claim 27, further comprising receiving feedback signals from the PWM valve, and monitoring operation of the PWM valve based on the feedback signals.

29. The method of claim 27, further comprising moving the jet nozzle to a purging station to be purged if a predetermined number of individual jet drops are not detected.

30. The method of claim 29, further comprising generating an alarm if a predetermined number of individual jet drops is not detected after the jet nozzle has been purged.

31. A fluxer comprising the monitoring system of claim 18.

32. A fluxer configured to perform the monitoring method of claim 27.
